(19) United States
(12) Patent Application Publication
(10) Pub. No.: US 2009/0217051 A1
(43) Pub. Date: Aug. 27, 2009

(54) Method for distribution of multimedia tracks through computer networks

(76) Inventor: Domenico Bacci, Bologna (IT)

Correspondence Address: MODIANO & ASSOCIATI, Via Meravigli, 16, Milano, 20123, IT

(21) Appl. No.: 12/379,067

(22) Filed: Feb. 12, 2009

(30) Foreign Application Priority Data
Feb. 13, 2008 (IT) MI2008A000221

(51) Int. Cl. H04L 9/32

(52) U.S. Cl. 713/176

(57) ABSTRACT

A method for distributing multimedia files through a computer network comprises the steps of selecting a multimedia track from an archive, encoded in a digital file according to a conventional encoding which comprises a header and a division into frames; converting a plurality of the conventionally encoded frames into encrypted frames; applying a digital signature in the header; generating an audio file which comprises a signed header, a plurality of frames with conventional encoding and a plurality of encrypted frames.

The present invention relates to a method and system for the distribution of multimedia tracks through computer networks, magnetic media and personal computers in general.

### BACKGROUND OF THE INVENTION

Currently, several kinds of methods and commercial tools are used to distribute music or video files through computer networks, particularly the Internet which, thanks to its millions of users, is one of the most interesting and effective markets but is also a source of illegal distribution of material.

The turnover and competition involved in the music/motion picture market therefore continuously require new methods and systems for promoting songs, videos and films, and at the same time for protecting the rights of the owner on copyrighted products. Until recently, promotion and distribution of songs, videos and films were performed almost exclusively through radio and television channels in a variety of programs. In this manner, the audio/video content, although copyrighted, reaches simultaneously a plurality of users in a manner that is completely cost-free for them, the costs of the promotion of the material being borne entirely by sponsors or advertisers. In recent years, the rapid growth of the Internet and the new technologies used to encode multimedia files on computer media have attracted the attention of millions of users. It is now possible to encode any audio/video track in a multimedia file in different formats and play it on a normal personal computer, and most of all to make a copy thereof without compromising at all the audio/video quality of the source file.

Moreover, the Internet makes it very easy to browse through a large quantity of archives that are available worldwide, looking for specific titles and finally downloading the desired multimedia track: recent market research has demonstrated that one of the most widely searched terms on the Internet is the word “MP3”, which refers to audio files encoded in a well-known compressed format.

In order to listen to an MP3 audio file, or likewise play a file that also contains video, for example encoded according to the MPEG4 standard, the user requires an MP3 or MP4 player. MP3/MP4 players are generally available in the form of a hardware apparatus or of a software application that runs on the personal computer of the user. Many MP3 and MP4 players are provided for free, and so are many MP3 audio and MP4 video files. The quality of MP3 files is very high, not far from that of a normal CD. Moreover, MP3s are much smaller in terms of size than their CD counterparts, approximately in a ratio of 1:12, which makes them suitable for downloading from a computer network, particularly the Internet.

Of course, Internet sites cannot legally provide MP3 files of copyrighted material unless authorized by the author or owner.

However, the very nature of the MP3 digital file, which can be played by any player that is compatible with the standard, makes copying of the audio track by means of user-to-user exchanges, without as mentioned any loss of quality between the copy and the original, extremely easy and uncontrollable.

The file protection attempts made so far are based substantially on protection by means of DRM schemes, which allow to play back the track with limitations (for example, only on the device indicated by the user at the time of purchase). However, even this protection is in practice scarcely useful, since while the audio/video file is being played by the player, it is in any case possible to make a simultaneous recording of the audio or video by means of conventional software programs, which generate an unprotected MP3 or MP4 file, once again without any loss of quality.

Likewise, it is in any case not unusual for the buyer of a CD or DVD to convert the files into MP3/MP4 format in order to then make them available for peer-to-peer exchanges, i.e., directly from a user's computer to another user's computer, by means of known programs for sharing and swapping files in general, such as e-Mule, BitTorrent and KaZaa, just to mention the best-known ones.

In the background art, attempts at music file distribution of the peer-to-peer type in a controlled manner are known. In particular, U.S. patent application Ser. No. 10/029,997 discloses a method for distributing music files in encrypted and tagged form in order to identify the chain of users who transferred the product. The encrypted file receives the addition of a portion of the same music content in unencrypted form, so as to allow to listen to part of the track.

### SUMMARY OF THE INVENTION

The aim of the present invention is to provide a method and a system for distributing music, films and videos, including copyrighted material, through a computer network, particularly the Internet, that overcome the problems observed above with reference to the background art.

Within this aim, an object of the present invention is to provide a method and a system that overcome the problem of the impossibility of protecting multimedia files, dissuading the user from illegally circulating copyrighted audio tracks and instead providing the user with an incentive to purchase the file legally.

A further object of the present invention is to provide a method and a system that do not encumber unnecessarily the quantity of data to be exchanged, avoiding in particular redundancies in content.

Another object of the present invention is to provide a method and a system that make a music file encoded according to the system preliminarily indistinguishable from a music file deposited according to the conventional method, for example in the MP3 format.

Still another object of the present invention is to provide a method and a system that allow authors and producers of music and of other multimedia content to approach the maximum possible number of users, by converting Internet channels from illegal distribution channels to channels for promoting their content.

This aim, these objects and others that will become better apparent hereinafter are achieved by a method for distributing music files through a computer network, comprising the steps of: selecting an audio/video track encoded in a digital file according to a conventional encoding which comprises a header and a division into frames; converting a plurality of said conventionally encoded frames into encrypted frames; applying a digital signature in the header; generating an audio file which comprises a signed header, a plurality of frames with conventional encoding and a plurality of encrypted frames.

This aim and these objects are also achieved by a digital file for personal computers, comprising a header which comprises a digital signature and a division into frames, said frames being divided into frames that are encoded according to conventional encoding and encrypted frames, and by a data encoder for personal computers, comprising means for applying a digital signature to a digital file which comprises a header and a division into frames, said frames being divided into frames that are encoded according to conventional encoding and encrypted frames.

Advantageously, such conventional encoding is MP3 encoding for music files and MP4 for films/videos.

Conveniently, the plurality of frames with conventional encoding comprises the initial sequence of consecutive frames that constitute the audio file and the plurality of encrypted frames comprises a sequence of consecutive frames.

### BRIEF DESCRIPTION OF THE DRAWINGS

Further characteristics and advantages of the present invention will become better apparent from the following detailed description, given by way of non-limiting example and illustrated in the accompanying drawings, wherein:

FIG. 1 is a schematic view of a network system used to distribute music/video files encoded according to the present invention;

FIG. 2 is a block diagram of a file that is encoded conventionally in the MP3 format;

FIG. 3 is a block diagram that represents a file encoded in the MP3 format and partially encrypted.

### DESCRIPTION OF THE PREFERRED EMBODIMENTS

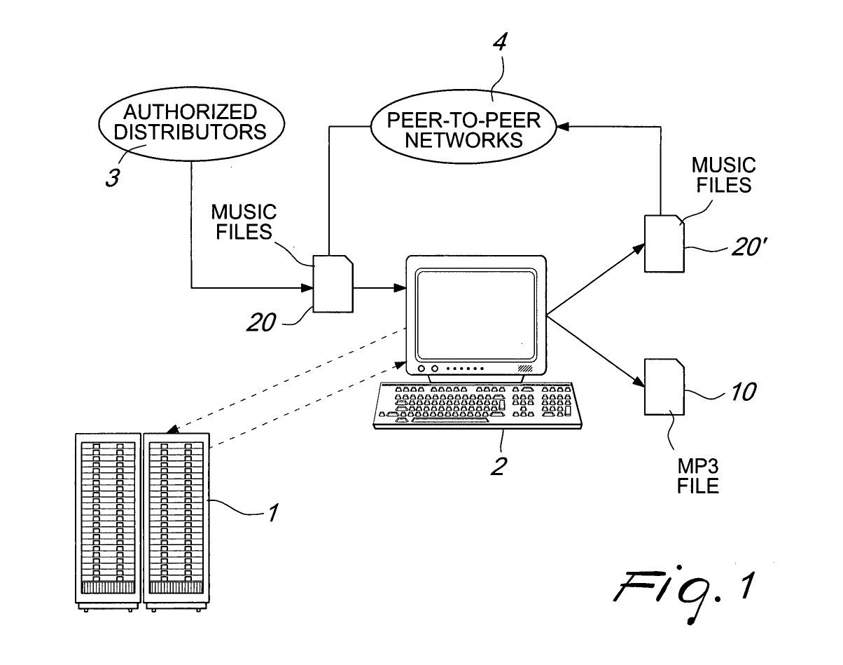

FIG. 1 is a general view of a preferred embodiment of the architecture of the system, where a user computer station 2 accesses, through a computer network, particularly the Internet, a server 1 of a service provider that acts as an operator and certifier in the management of music files 20 distributed through official distributors 3 or peer-to-peer networks 4.

In greater detail, the server 1 of the certifier contains means for verifying the authenticity of the data sent by the client 2 and for providing the information needed to apply digital signatures to music files 20, as will be explained hereinafter.

The client 2 is an application, to be installed at the station of each user, that allows to select music files 20 and, under the control of the server 1 and/or in cooperation with it, to apply thereto one's own digital signature, so as to generate a version of the music file 20′ that can be associated with the user.

The authorized distributors 3 represent all the distributors that put on the market music/video files stored on digital media, be they CDs, DVDs, memory cards or others, or distributors that allow to download directly onto one's own computer the music files one is interested in, according to the most recent distribution models.

The peer-to-peer networks 4 instead represent all the applications that allow to share among users in a network files of any kind and are often used for the unauthorized sharing and distribution of copyrighted material.

The music file 10 is an audio/video file encoded according to any encoding mode that can be understood by an audio/video player. By way of non-limiting example, the present description will always reference files encoded in the MP3/MP4 format, since these standards are the best-known and most widespread commercially for the encoding of music and video files. However, files that use similar structures, such as files in the XVID, DIVX or Ogg/Vorbis format are of course suitable for the application of the invention.

It should be noted that for the sake of simplicity in explanation, the present description refers to files of the musical type, and specifically to files of the MP3 type. However, this description must be understood merely as a non-limiting example, since the same considerations apply to any type of multimedia file, i.e., audio, video or audio-video, constituted by a frame composed of a succession of fields.

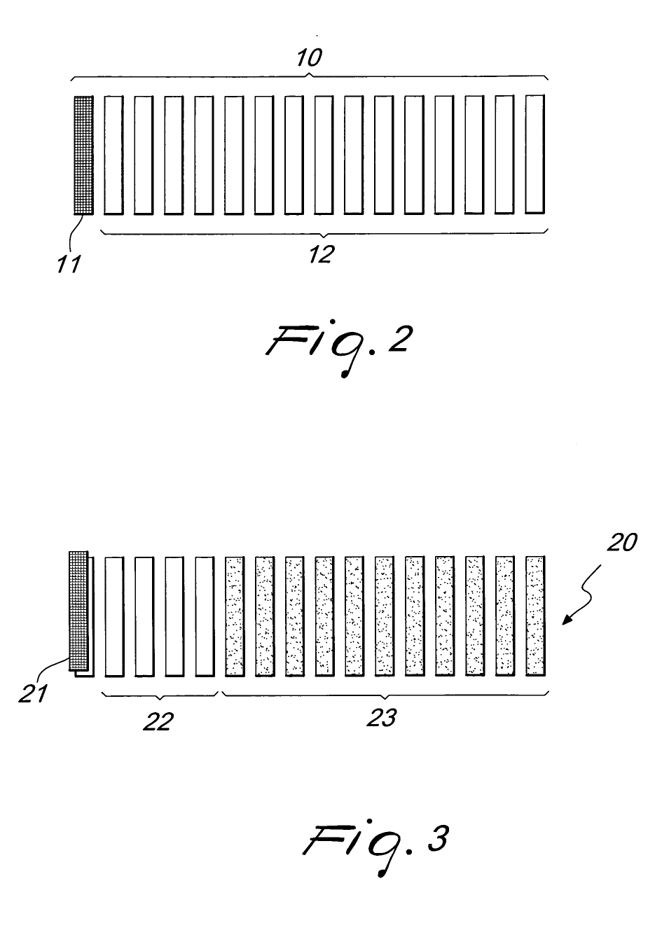

The MP3 file 10 is shown in greater detail in FIG. 2, where it is shown that the MP3 file, like most files encoded according to any other layer of the MPEG standard, is constituted by a sequence of independent frames, each of which is independent.

In particular, FIG. 2 illustrates a first portion 11 of the file, identified as ID3 area, which stores corollary data, such as for example data related to the ownership of the file, such as the Author, Major, Producer, Internet retailer, distributor and so forth.

FIG. 3 instead illustrates an audio file 20 that is signed and encrypted according to the present invention.

In this case, the header area 21 bears, in addition to the data mentioned above, also the digital signature of the client 2 used by the user or a unique identifier that acts as a key to associate the data mentioned above, such as the Author, Major, producer, Internet retailer and so forth, on the server side.

Moreover, there is therein a first plurality of frames 22 encoded according to the standard and left unencrypted and a second plurality of encrypted frames 23. In this manner, the portion 22 of the music file can still be played by means of any MP3 player, while the portion 23 cannot be played, since the encryption process compromises the possibility of interpretation by a conventional player.

Operation of the system is as follows.

A first user 2 personally produces a music file and identifies himself and accredits himself at the server 1.

Otherwise, he comes into possession of an unencrypted music file, for example by purchasing a file on the Internet or on a memory medium, in the form of a CD, a DVD, a memory card or any other medium suitable to store digital data, through authorized distributors 3. The medium contains, in addition to the music files in a format that can be played by means of the corresponding player, also a copy 20 of the files encoded in MP3 format and partially encrypted, each containing its own identification code.

The memory medium, or its package, bears internally, in electronic and/or paper format, the access keys that allow the user, once he has connected to an appropriately provided Internet site, which in turn is connected to the server 1, to identify himself as a user who has regularly purchased the content of the CD and the unlocking code of the tracks 20.

Likewise, if the distributor is a distributor of music in digital format over the Internet that allows the user to download music directly into his own personal computer, the user can be provided with two versions of the tracks that he has selected: a freely playable version 10 and an encrypted version, accompanied by the same information mentioned above.

Both encoding and encryption can of course be performed by using any appropriate encoding or encryption algorithm, widely known in computer literature, as well as proprietary protection schemes or algorithms that are compatible with the formats used.

Once the user 2 has come into possession of the audio/video files he is interested in, in addition to playing the audio or video, he may decide, as often occurs, to share them with the other users of the network by means of peer-to-peer channels. However, instead of circulating the normally encoded and freely playable version, by means of the client 2 he applies, if it is not already present in the file 20 received from the distributor, his own signature in the portion 21 of the encrypted file 20 and circulates the partially encrypted version of the track.

At this point, a third user who might come into possession of the file 20 will be able to play back only the portion 22 of the music file 20.

However, by connecting to the server 1 he will be able to notify to the server 1 his intention to purchase a copy of the track, by using the file 20, or the digital signature contained therein, as a starting point, thus generating an income, in the form of a refund or credit according to appropriate cost schemes that are beyond the technical context of the present invention, for the user who circulated the encrypted or partially encrypted file 20 and for the other rights holders (Author, Major, et cetera).

As a consequence of the purchase made, the third user also receives a copy of the file 20 that is partially encrypted and which he can decide in turn to circulate after applying his own digital signature in the section 21.

It has been shown that the present method and system achieve the intended aim and objects. Since the user obtains a tangible benefit from the distribution of music/video files in partially encrypted form according to the described schemes, he in fact loses interest in circulating illegal copies of the music tracks.

At the same time, the possibility of economic returns on purchase by other users, encouraged by the partial playing of the file 20, of such track, prompts the user to circulate the encrypted files as much as possible, contributing to the distribution of the track, to the full benefit of the author, of the distributor and all the chain of the rights holders, who benefit, and no longer suffer, from the distribution of files over the computer network.

Moreover, thanks to the encryption of frames in a separate manner, it is possible to keep portions of the track unencrypted, so as to allow partial playing thereof without having to replicate content in a redundant manner. Likewise, the structure of the file remains unchanged, thus making the content of the file encoded according to the teachings of the invention formally indistinguishable from a corresponding file encoded in a conventional manner.

Numerous modifications are clearly possible and can be readily performed by the person skilled in the art without abandoning the scope of the protection of the present invention. For example, it is clear that the present invention can be applied also for the distribution of music/video files independently of the Internet. A financial sponsor, for example, might use the method according to the present invention to generate executable software files that can be distributed through different channels, for example on compact discs included in music or computer magazines or as bonuses in video games or computer programs in general. Moreover, it is equally evident that the application of the digital signature in the portion 21 of the file 20 can be performed directly by the server 1 or by the distributor 3 if the user has been identified, and that such digital signature can replace preceding signatures or be added to them in order to generate repayment schemes of a different type (for example of the type known as “multilevel”).

Finally, it is clear that the operations for partial or total encryption of the file can be performed directly by the client 2 on the basis of his own digital signature.

Therefore, the scope of the protection of the claims must not be limited by the illustrations or by the preferred embodiments illustrated in the description by way of example, but rather the claims must include all the characteristics of patentable novelty that reside within the present invention, including all the characteristics that would be treated as equivalent by the person skilled in the art.

The disclosures in Italian Patent Application no. MI2008A000221, from which this application claims priority, are incorporated herein by reference.

What is claimed is:

1. A method for distributing multimedia files through a computer network, comprising the steps of:
selecting a multimedia track from an archive, encoded in a digital file according to a conventional encoding which comprises a header and a division into frames;
converting a plurality of said conventionally encoded frames into encrypted frames;
applying a digital signature in said header;
generating an audio file which comprises a signed header, a plurality of frames with conventional encoding and a plurality of encrypted frames.

2. The method according to claim 1, wherein said multimedia file is an audio file.

3. The method according to claim 1, wherein said multimedia file is an audio/video file.

4. The method according to claim 2, wherein said conventional encoding is MP3 encoding.

5. The method according to claim 3, wherein said conventional encoding is MP4 encoding.

6. The method according to claim 1, wherein said plurality of frames with conventional encoding comprises the initial sequence of consecutive frames that constitute the multimedia file.

7. The method according to claim 6, wherein said plurality of encrypted frames comprises a sequence of consecutive frames.

8. A data encoder for personal computers, comprising:
means for applying a digital signature to a digital file comprising a header and a division into frames, said frames being divided into frames that are encoded according to a conventional encoding and into encrypted frames.

9. The data encoder according to claim 8, wherein said digital file is an audio file.

10. The encoder according to claim 1, wherein said digital file is an audio/video file.

11. The data encoder according to claim 9, wherein said conventional encoding is MP3 encoding.

12. The data encoder according to claim 10, wherein said conventional encoding is MP4 encoding.

13. A digital file for personal computers, comprising a header that comprises a digital signature and a division into frames, said frames being divided into frames that are encoded according to conventional encoding and into encrypted frames.

14. The digital file according to claim 13, wherein said digital file is an audio file.

15. The digital file according to claim 14, wherein said digital file is an audio/video file.

16. The digital file according to claim 14, wherein said conventional encoding is MP3 encoding.

17. The digital file according to claim 15, wherein said conventional encoding is MP4 encoding.

18. The digital file according to claim 13, wherein said plurality of frames in conventional encoding comprises an initial sequence of consecutive frames.

19. The digital file according to claim 18, wherein said plurality of encrypted frames comprises a sequence of consecutive frames.
